(19) United States
(12) Patent Application Publication
(10) Pub. No.: US 2015/0161542 A1
(43) Pub. Date: Jun. 11, 2015

(54) INTEGRATION BETWEEN PROJECT PLANNING SYSTEM AND BUSINESS SYSTEM

(71) Applicant: Microsoft Corporation, Redmond, WA (US)

(72) Inventors: Babak Nakhayi Ashtiani, Sammamish, WA (US); Muhammad Tahauddin Ahmad, Redmond, WA (US); Suyesh Subhash Chaudhari, Bellevue, WA (US); Revathi Nellainayagi Muthiah, Kirkland, WA (US)

(73) Assignee: Microsoft Corporation, Redmond, WA (US)

(21) Appl. No.: 14/097,436

(22) Filed: Dec. 5, 2013

(51) Int. Cl. G06Q 10/06

(52) U.S. Cl. CPC G06Q 10/06313

(57) ABSTRACT

A project management system receives project planning inputs from a user, to create and plan a project. It receives a publication input, publishing the project, to a business system and receives financial and operational reference data from the business system. It also receives resource data from the business system and provides a resource user interface display that allows a user to staff the project with resources received from the business system.

### BACKGROUND

Computer systems are currently in wide use. Some computer systems include project planning and management systems, as well as business systems. These two types of systems are not normally integrated.

A project planning system often provides functionality that allows a user to perform operational project planning. For instance, such systems often allow a user to provide inputs to create a work breakdown structure (or other work definition) which defines a project that is to be completed. The project is often defined in terms of tasks or other items in the work definition. Each task can have a description, a duration, a start date, an end date, etc. A project planning system thus allows a project manager to create a new project, and manage the project, while it is being performed.

There are also a wide variety of different kinds of business systems. Such systems often include enterprise resource planning (ERP) systems, customer relations management (CRM) systems, line-of-business (LOB) systems, among others.

Business systems normally include functionality that allows a user to perform project accounting, such as to estimate cost and revenues based on various projects. They also normally include some type of management module for managing human capital (such as human resources) and other resources. By way of example, they often allow users to assign workers to various tasks, so that they can record time and expenses against those tasks, for accounting purposes.

The discussion above is merely provided for general background information and is not intended to be used as an aid in determining the scope of the claimed subject matter.

### SUMMARY

A project management system receives project planning inputs from a user, to create and plan a project. It receives a publication input, publishing the project, to a business system and receives financial and operational reference data from the business system. It also receives resource data from the business system and provides a resource user interface display that allows a user to staff the project with resources received from the business system.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one illustrative project management architecture.

FIGS. 2A and 2B (collectively FIG. 2) show a flow diagram that illustrates one embodiment of the operation of the architecture shown in FIG. 1.

FIGS. 3A-3I show exemplary user interface displays.

FIG. 4 shows one embodiment of the architecture shown in FIG. 1, deployed in a cloud computing architecture.

FIGS. 5-10 show examples of mobile devices.

FIG. 11 is a block diagram of one illustrative computing environment.

### DETAILED DESCRIPTION

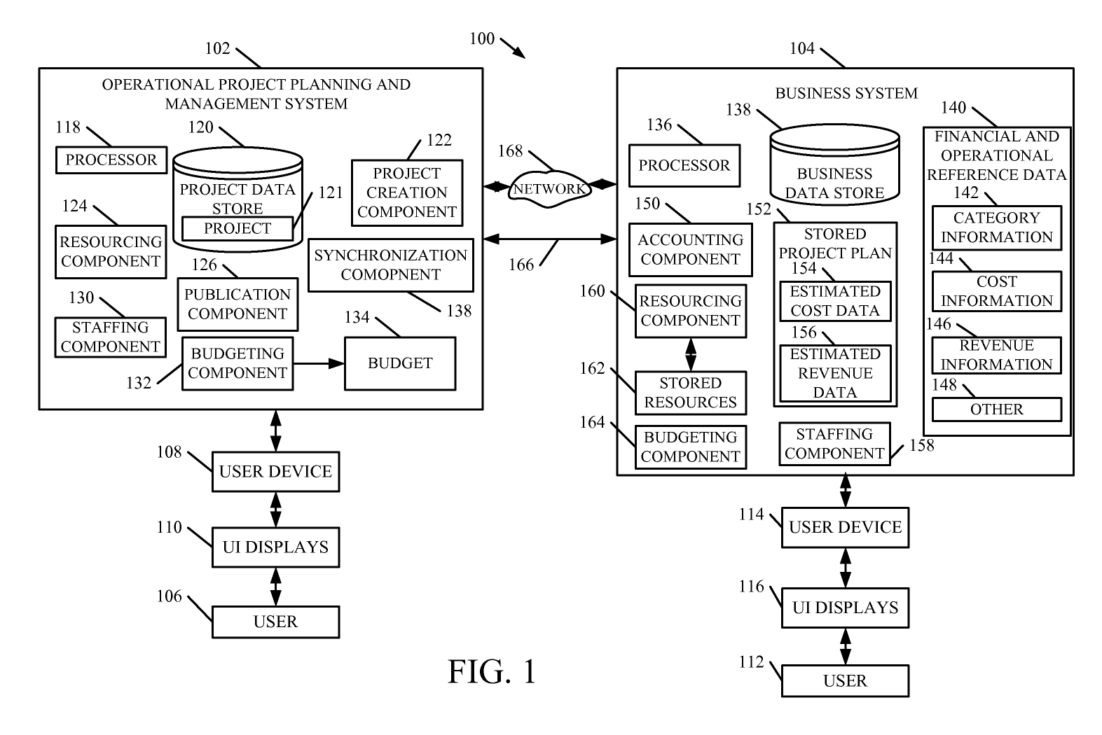

FIG. 1 shows a block diagram of one illustrative project management architecture 100. Architecture 100 illustratively includes an operational project planning and management system (hereinafter referred to as a project planning system) 102 that communicates with a business system 104. Project planning system 102 is illustratively accessible by a user 106 through a user device 108 that displays user interface displays 110 for interaction by user 106. User 106 can interact with the user interface displays 110 to control and manipulate system 102. Business system 104 is also illustratively accessible by a user 112 (which can be the same as user 106 or different) through user device 114 (which can be the same as device 108 or different) that displays user interface displays 116 for interaction by user 112. User 112 interacts with user interface displays 116 to control and manipulate system 104.

FIG. 1 shows that project planning system 102 illustratively includes processor 118, project data store 120, project creation component 122, resourcing component 124, publication component 126, synchronization component 128, staffing component 130, and budgeting component 132 that is shown providing an output as budget 134. Business system 104 illustratively includes processor 136, business data store 138, financial and operational reference data 140 that, itself, includes category information 142, cost information 144, revenue information 146 and other information 148. Business system 104 also illustratively includes accounting component 150 that provides information to stored project plan 152. Plan 152 illustratively includes estimated cost data 154 and estimated revenue data 156, among other things. Business system 104 also illustratively includes staffing component 158, resourcing component 160 that is shown accessing stored resources 162, and budgeting component 164.

In the embodiment shown in FIG. 1, project planning system 102 can communicate with business system 104 directly, as indicated by arrow 166. Also, in one embodiment, system 102 can communicate with system 104 over a network 168, which can be a local area network, a wide area network, or another type of network.

It should also be noted that user devices 108 and 114 can communicate with project planning system 102 and business system 104, respectively, either directly, or over a network. They are shown as communicating directly, but communication over a wide area network, a local area network, or another network, is contemplated herein as well.

Before describing the operation of architecture 100 in more detail, a number of the items in each of systems 102 and 104 will be described briefly, and a brief overview of the operation of architecture 100 will be provided, in order to enhance understanding.

Project creation component 122 illustratively generates user interface displays 110 with user input mechanisms that can be actuated by user 106 in order to create and manage a project (or project plan) 121. Once a project 121 is created, publication component 126 intermittently publishes the project 121 to business system 104. Synchronization component 128 illustratively synchronizes changes made to the project 121 in project planning system 102, with the project as defined in business system 104.

Processors 118 and 136 are illustratively computer processors with associated memory and timing circuitry, not separately shown. They are illustratively functional parts of the systems to which they belong and are activated by, and facilitate the functionality of, the other components or items in those systems. In addition, multiple processors can be used in each system, although only a single processor is shown for the sake of example.

Data stores 120 and 138 are shown as single data stores, and they are local to the systems to which they belong. However, they can be comprised of multiple different data stores as well. In such an embodiment, all of the data stores can be local to the system to which they belong, all can be remote, or some can be local while others are remote.

Resourcing component 124 in project planning system 102 illustratively generates user interface displays that allow user 106 to access stored resources 162 through the resourcing component 160 in business system 104. Staffing component 130 illustratively allows user 106 to assign selected resources to selected tasks within a project in project planning system 102.

Budgeting component 132 illustratively generates user interface displays 110 that allow user 106 to generate a budget 134 for the project. For instance, when a project is published to business system 104, accounting component 150 illustratively exposes financial and operational reference data 140. Data 140 is shown separate from business data store 138, but it can also be stored within data store 138. It illustratively includes category information 142 that allows user 106 to map tasks in the newly created project 121 to task categories within business system 104. Accounting component 150 also makes cost information and revenue information 144 and 146, respectively, available to user 106 so that costs and revenues can be associated with the tasks in the project 121, and so budget 134 can be generated.

Accounting component 150 also illustratively generates a project plan 152 corresponding to the new project 121 in project planning system 102. It illustratively generates estimated cost data 154 and revenue data 156 within business system 104, corresponding to the newly created project plan 152.

When resourcing component 124 receives an input from user 106 to access resources in order to staff the project, resourcing component 160 in business system 104 exposes the stored resources 162 in business system 104, for access by user 106. The resources can be human capital resources, or a variety of other resources. When staffing component 130 in project planning system 102 receives a user input selecting resources for being assigned to the project, staffing component 158 assigns the selected resources to the stored project plan 152 so that the resources can begin billing time and expenses against the project within the business system 104. As briefly mentioned above, accounting component 150 can also estimate the cost and revenues, corresponding to the tasks in the project, and based upon the individual resources that have been assigned to that project. This information is illustratively provided to budgeting component 132 in project planning system 102 so that user 106 can generate and execute on budget 134.

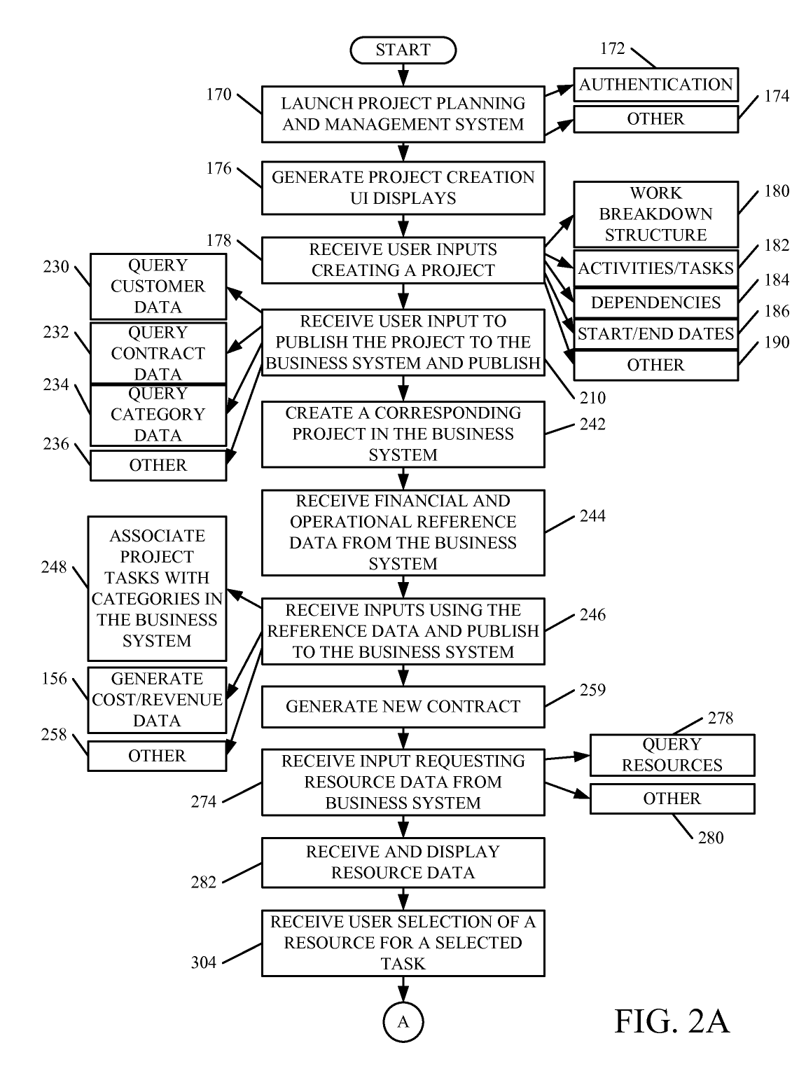

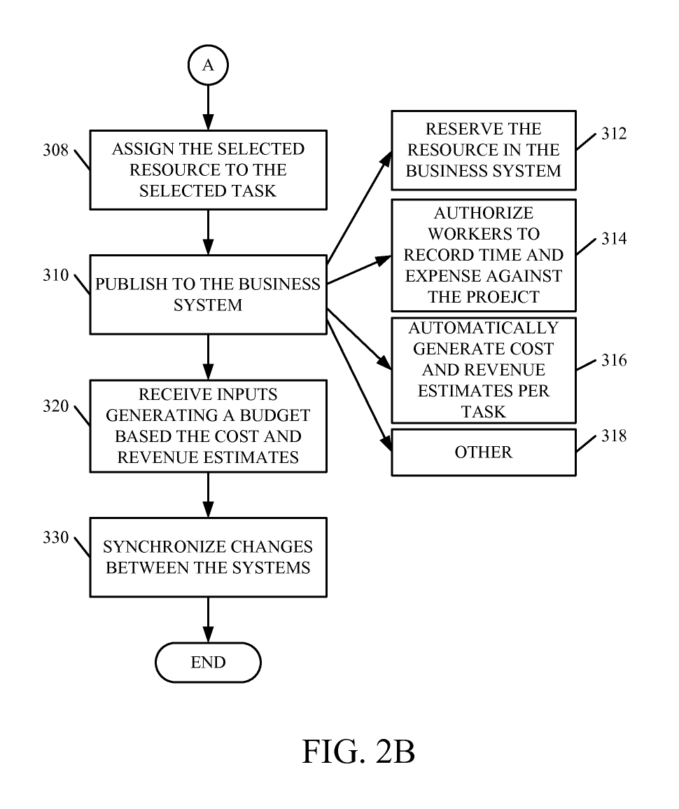

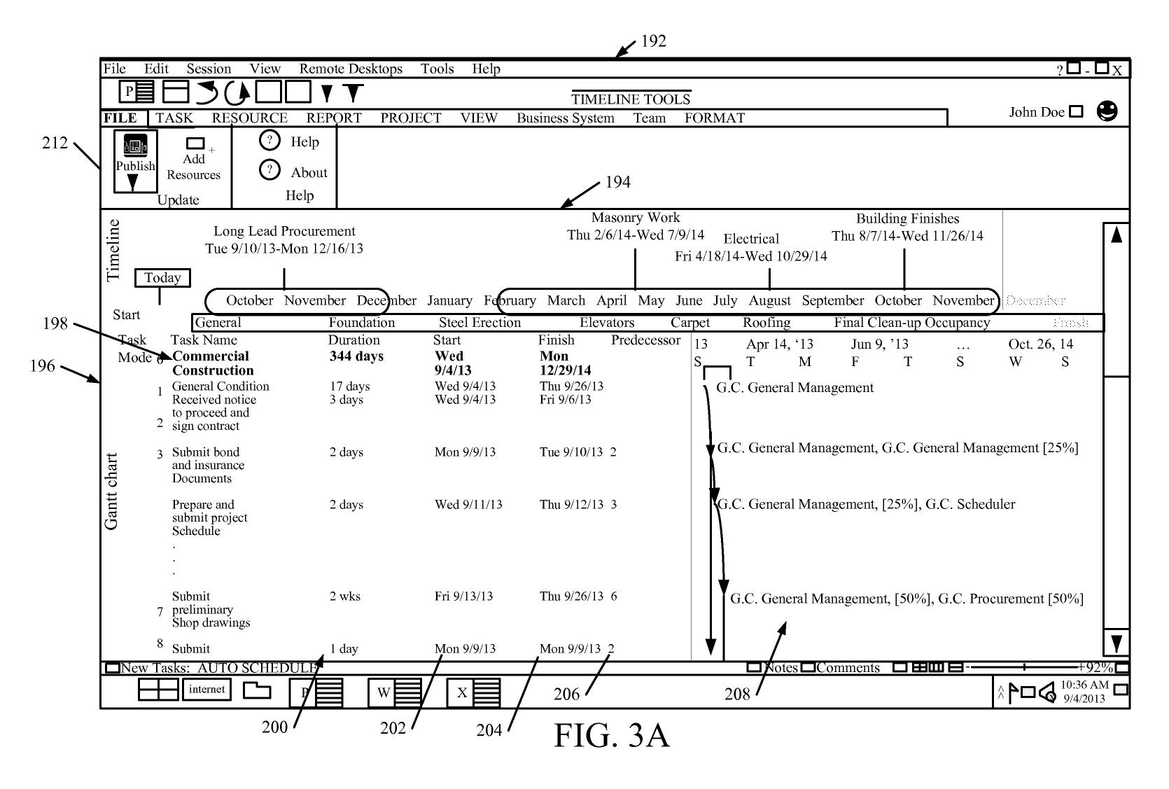

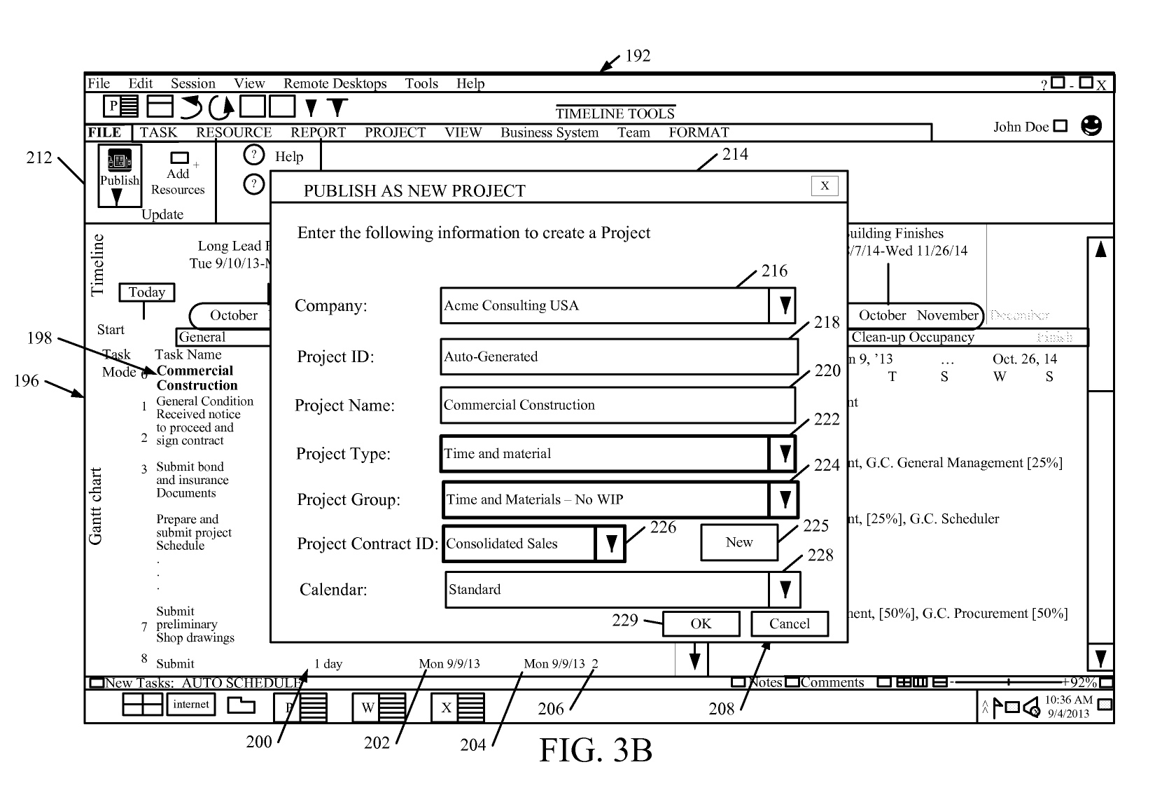

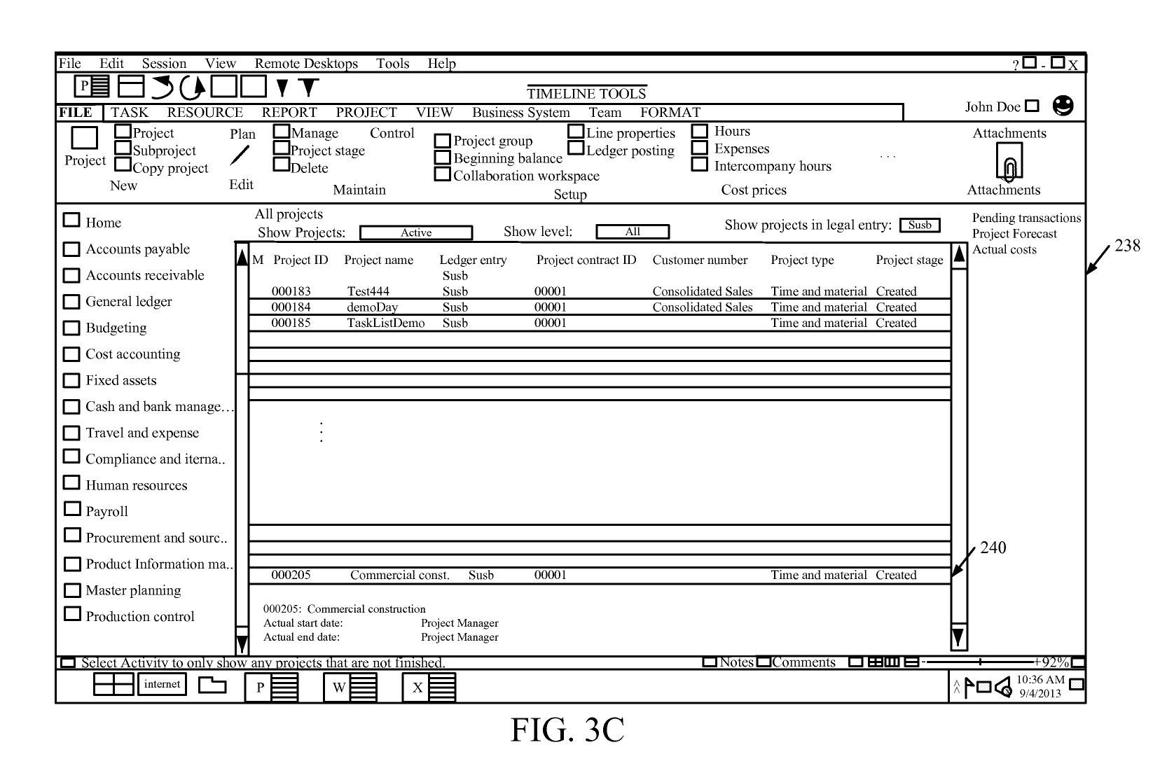

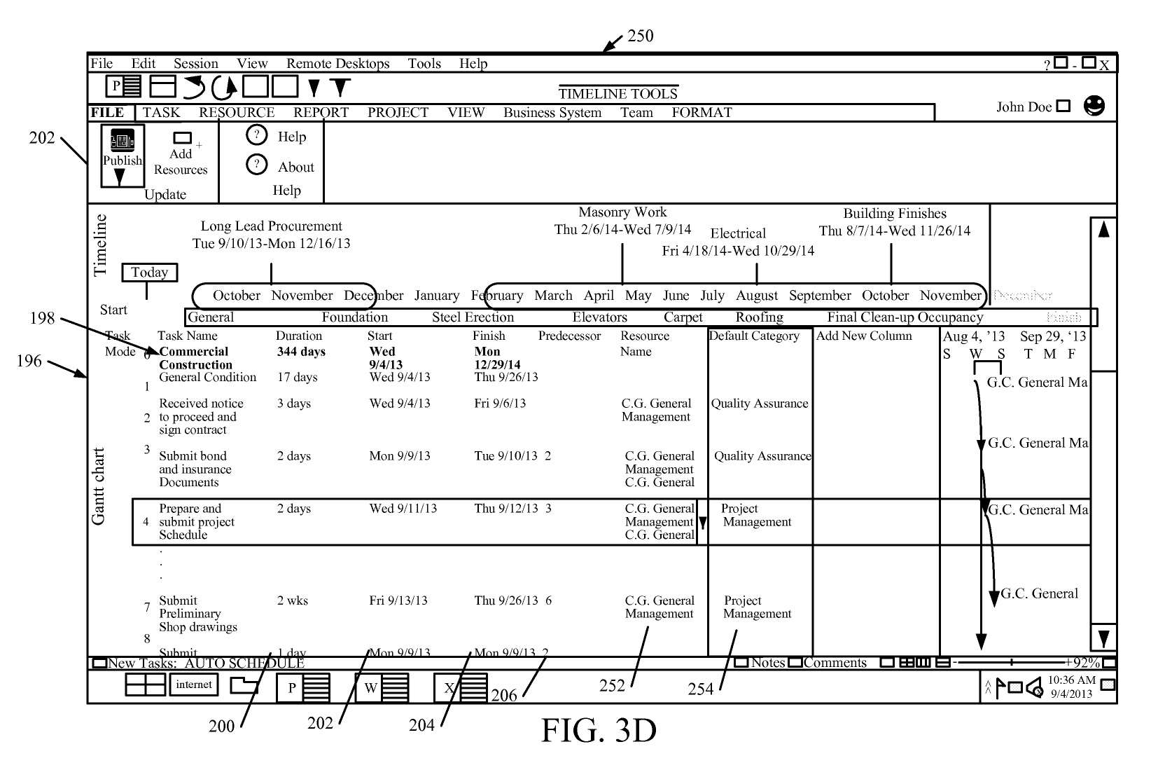

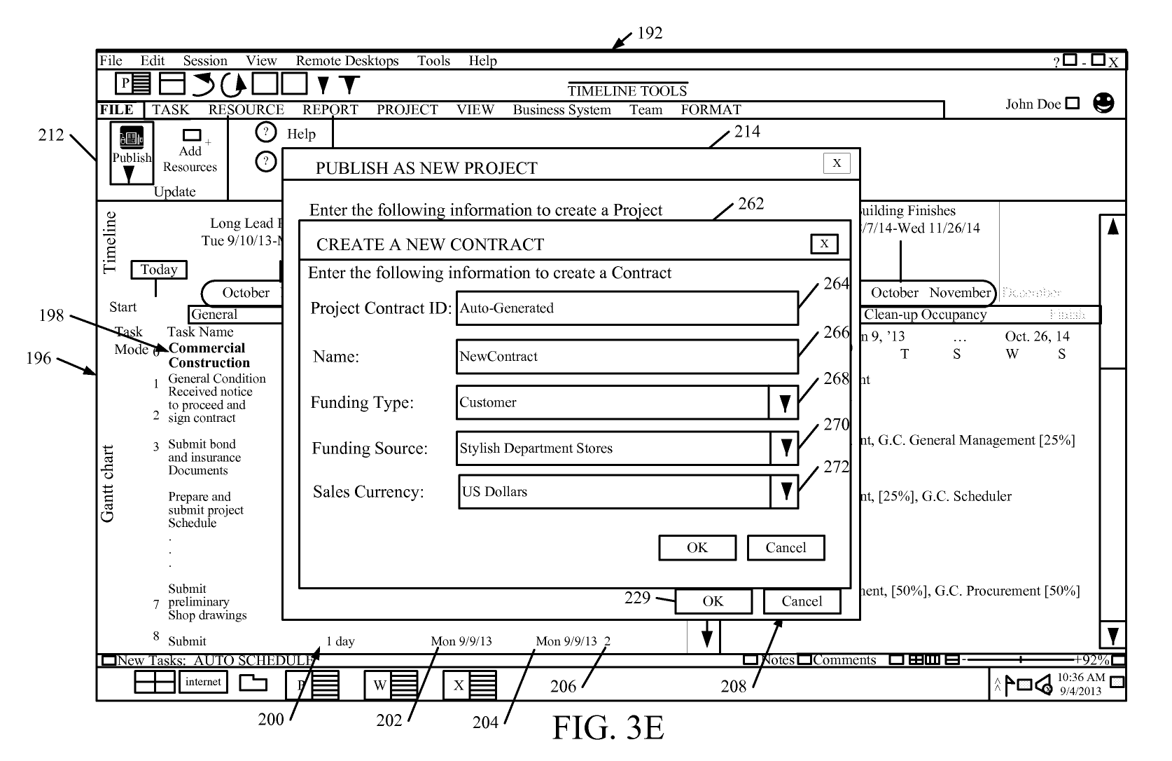

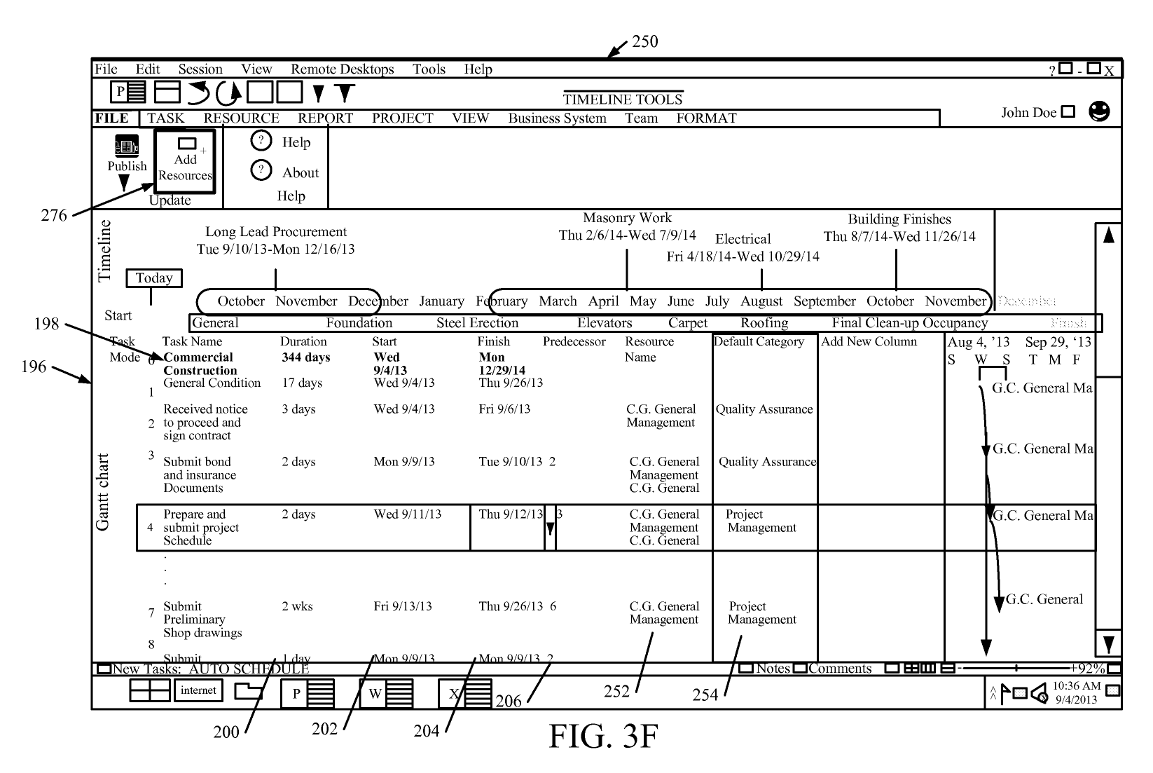

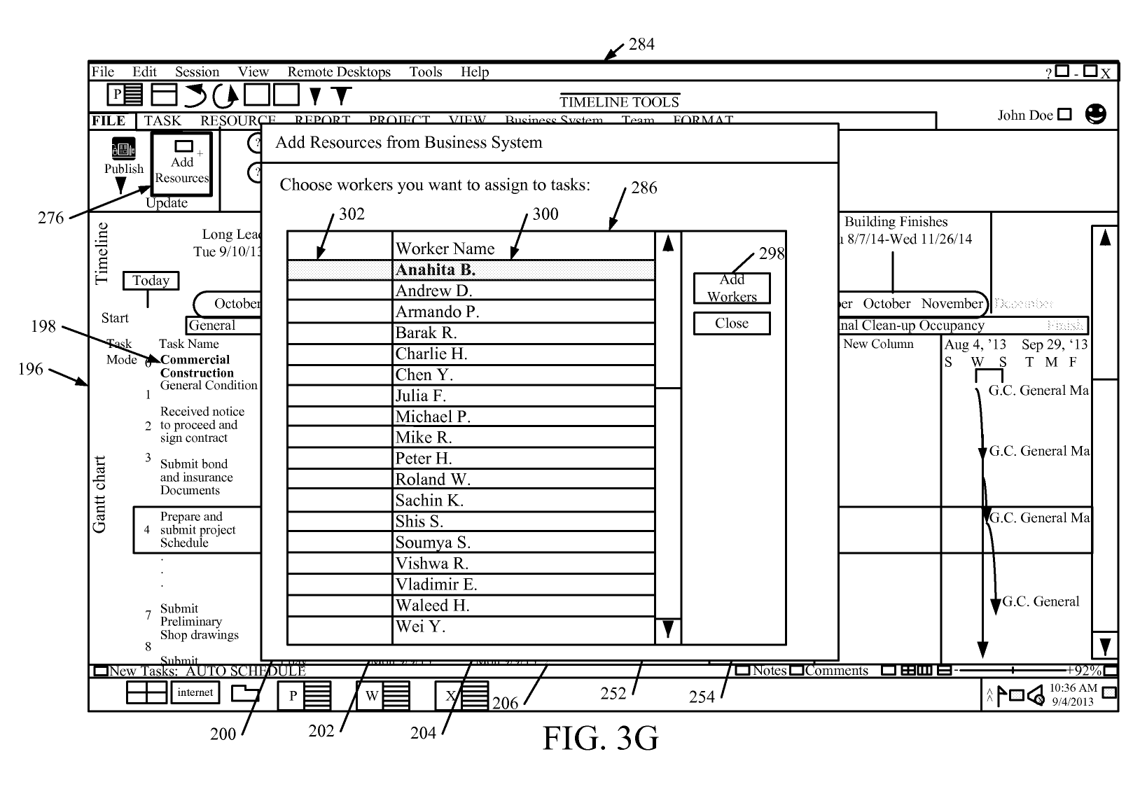

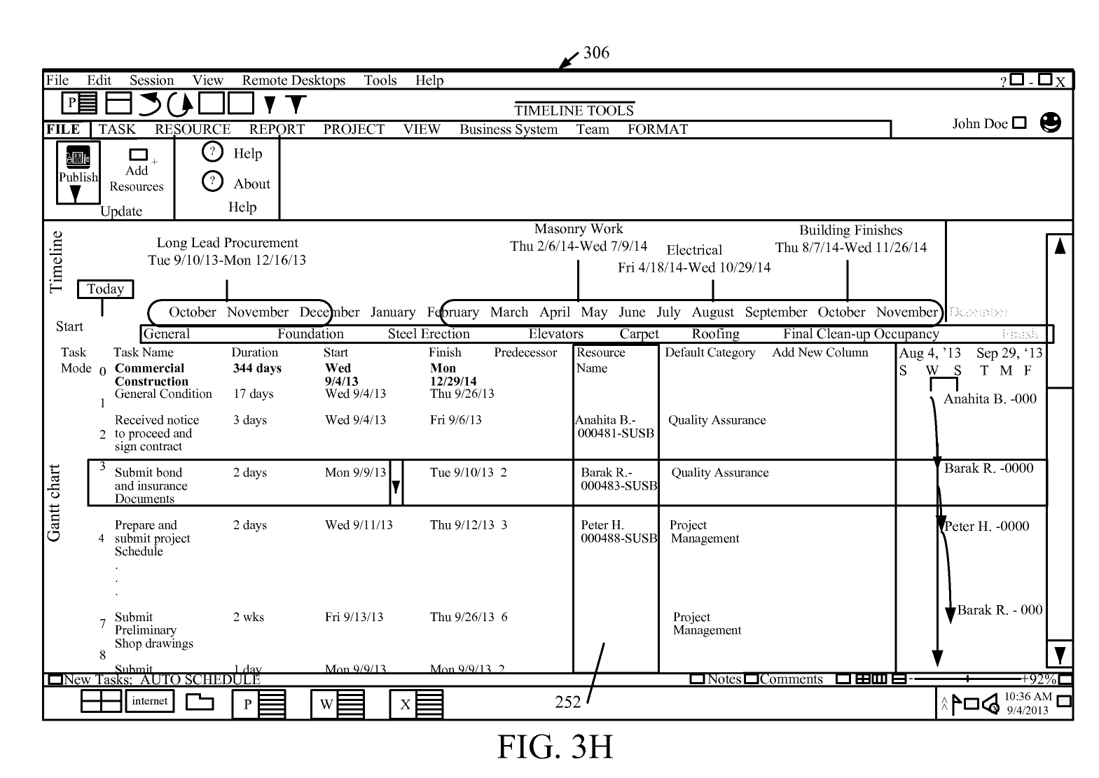

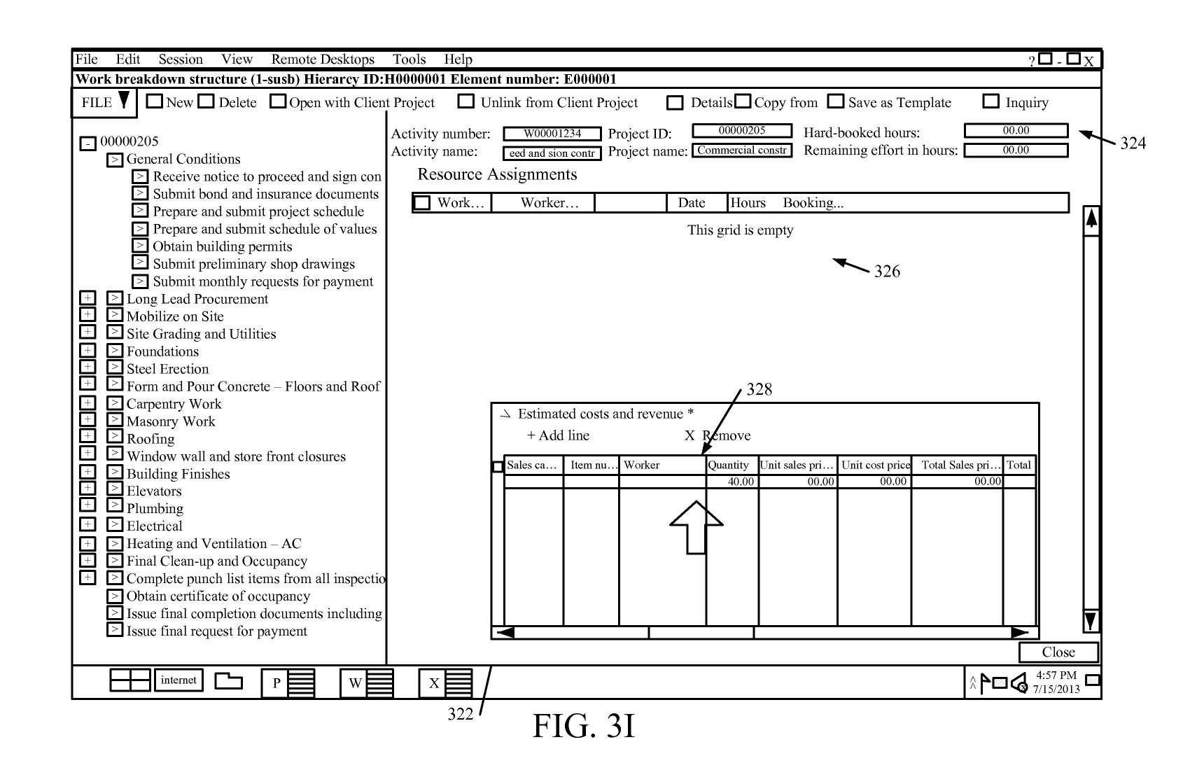

FIGS. 2A and 2B (collectively FIG. 2) show a flow diagram illustrating the operation of architecture 100 in more detail. FIGS. 3A-3I show illustrative user interface displays that can be generated as displays 110 for user 106. FIGS. 2A-3I will now be described in conjunction with one another.

In one embodiment, user 106 first launches project planning system 102 by providing suitable inputs through user interface displays 110. This is indicated by block 170 in FIG. 2. Such inputs can include authentication inputs (such as a username and password) as indicated by block 172, or other inputs 174.

Project creation component 122 then illustratively generates user interface displays, with user input mechanisms that can be actuated by user 106, in order to generate project 121. This is indicated by block 176 in FIG. 2.

User 106 then provides user inputs, through the user interface displays, in order to create project 121. This is indicated by block 178 in FIG. 2. The user inputs can be provided in order to define a work breakdown structure 180 that divides the project into activities or tasks 182, and establishes dependencies among those tasks, as indicated by block 184, as well as such things as start and end dates 186. Of course, the user can provide other inputs in creating the project as well, and this is indicated by block 190.

FIG. 3A shows one embodiment of an illustrative user interface display 192 in which the user has begun to create a new project. Display 192 illustratively includes a timeline 194 and a set of tasks 196, each of which correspond to the project (the title of which is shown at 198 as “commercial construction”) that is being created. Each task illustratively includes a duration 200, and a start and end date 202 and 204, respectively. Each task can have its predecessor task noted in column 206. Thus, for example, it can be seen that task number 3 has, as its predecessor, task number 2. Thus, in one embodiment, task number 3 cannot be started until task number 2 is completed. In the embodiment shown in FIG. 3A, the project also includes a hierarchical structure 208 that shows the various tasks displayed in a hierarchy, or dependency tree.

Referring again to the flow diagram of FIG. 2, once the user has created a project, the user can provide a user input to publish the project to the business system. Receiving the user input and publishing the new project to business system 104 is indicated by block 210 in FIG. 2. By way of example, and referring again to FIG. 3A, the user can illustratively actuate a “publish” user input mechanism 212. In response, publication component 126 in project planning system 102 illustratively publishes the project 121 to business system 104. In doing so, publication component 126 can also query business system 104 for a variety of different things. Once the user has actuated the “publish” user input mechanism 212, publication component 126 can also prompt the user for any additional information that may be needed. FIG. 3B shows one example of this.

It can be seen that the user interface display shown in FIG. 3B is similar to that shown in FIG. 3A, and similar items are similarly numbered. However, FIG. 3B also shows that publication component 126 illustratively generates a pop-up display 214 that prompts the user for additional information. For instance, it can ask the user to enter a company name using user input mechanism 216, a project ID using input mechanism 218, for a project name, project type, project group and project contract ID using input mechanisms 220, 222, 224 and 226 respectively. It can also ask the user to specify the type of calendar being used, as indicated by mechanism 228. In the embodiment shown, the user has already put in the company and project name when creating the project. The user is thus simply asked in display 214 to specify the project type (such as time and materials or other project type), the project group and the project contract identifier.

Publication component 126 then illustratively publishes the new project 121 to business system 104. In doing so, publication component 126 can illustratively query business system 104 for a number of things. For instance, it can query business system 104 for customer data, as indicated by block 230 in the flow diagram of FIG. 2. The customer data may be data that has been entered for this particular customer in the past, or other data. It can also query business system 104 for contract data 232. The contract data may be data that has been entered on other projects, for contracts of this type. Publication component 126 can also illustratively query business system 104 for category data 234. The category data is illustratively data that identifies categories within business system 104 that map to the particular tasks entered by user 106 in creating the new project 121. Thus, each task can be assigned by the user to a given category within the business system 104. In another embodiment, they can be automatically assigned or automatically assigned and confirmed by the user. Publication component 126 can query business system 104 for other information as well. This is indicated by block 236 in the flow diagram of FIG. 2.

In response to publishing project 121 to business system 104, business system 104 not only makes available the financial and operational reference data 140 that has been queried by publication component 126 in project planning system 102, but it will also illustratively creates and stores a project plan 152, corresponding to the newly created project 121. Therefore, business system 104 has created its own record of a project plan 152, based upon the information provided by project planning system 102, for the newly created project 121. When this occurs, a user 112 that is accessing business system 104 will illustratively see that the new project has been created within business system 104. FIG. 3C shows one example of this.

FIG. 3C shows a user interface display 238 that is generated in response to user 112 requesting a list of all projects within business system 104. It can be seen generally at 240, that one of the projects within business system 104 corresponds to the “commercial construction” project 121 that was created in project planning system 102. Creating the corresponding project 152 within business system 104 is indicated by block 242 in the flow diagram of FIG. 2.

Project creation component 122 then receives the information that was queried for, when the project 121 was published to business system 104, and places that information in the proper locations within project 121 in project planning system 102. In the example being described, project creation component 122 illustratively receives the financial and operational reference data 140, that was queried for by publication component 126, from business system 104. Receiving such information is indicated by block 244 in FIG. 2. In one embodiment, instead of automatically placing that information in the proper location in project 121, project creation component 122 receives user inputs that select the information returned by business system 104, and place it in the proper location. Once this occurs, publication component 126 can then republish project 121, with the new information added, back to business system 104 in order to update the stored project plan 152, with the new information. Receiving inputs using the reference data and placing it in project 121, and then republishing project 121 to business system 104 is indicated by block 246 in FIG. 2.

By way of example, project creation component 122 can receive user inputs associating project tasks within project 121 with categories that were returned by the business system 104. This is indicated by block 248. FIG. 3D shows one embodiment illustrating this. FIG. 3D shows a user interface display 250 that is similar to user interface display 192 shown in FIG. 3A, and similar items are similarly numbered. However, it can be seen that the project, as displayed on user interface display 250, now includes two additional columns—the resource names column 252 and the default category column 254. In one embodiment, the resource names information in column 252 was returned in response to a query by publication component 126. It provides a name of a resource category that can be used to assign resources to each task in the project. The default category information displayed in column 254 illustratively includes default categories to which each of the tasks in project 121 can be assigned within business system 104.

When business system 104 receives an indication of the particular categories that are assigned to each of the tasks within project 121, accounting component 150 can illustratively estimate cost data 154 and revenue data 156 corresponding to each of those tasks. This is indicated by block 256 in the flow diagram of FIG. 2. The user can provide inputs to use other reference data in other ways. This is indicated by block 258 in FIG. 2.

Once the cost and revenue data have been estimated, the user 106 may wish to generate a new contract for the customer on the project. This can be done in a variety of different ways. For instance, project planning component 102 can illustratively generate a display such as that shown in FIG. 3E. The display shown in FIG. 3E is similar to display 192 shown in FIG. 3B, and similar items are similarly numbered. However, in FIG. 3B, the user illustratively actuates the “new” user input mechanism 225 instead of the “OK” user input mechanism 229. When the “new” mechanism 225 is actuated, pop-up display 262 is illustratively generated which prompts the user for more information that may be used in creating a new contract. The information can include a project contract ID as requested using mechanism 264, the contract name as requested using mechanism 266, the customer which can be selected using mechanism 268, the funding source which can be input using mechanism 270, and the sales currency that can be input using mechanism 272. When the user provides this information, a new contract is illustratively generated within project planning system 102. This can be synchronized using synchronization component 128 (or publication component 126) to business system 104 which illustratively generates its own representation of the contract within business system 104.

Referring again to the flow diagram of FIG. 2, at some point user 106 may wish to identify resources that can be used in order to staff project 121. User 106 thus illustratively provides an input indicative of this. For instance, FIG. 3F shows a user interface display that is similar to that shown in FIG. 3D, and similar items are similarly numbered. However, in the embodiment shown in FIG. 3F, the user illustratively actuates user input mechanism 276 indicating that the user 106 wishes to add resources to the opened project 121.

Resourcing component 124 then illustratively queries resourcing component 160 in business system 104 for resources 162 that can be used to staff the various tasks and activities in project 121. They are illustratively returned to project planning system 102 and displayed for user 106. Of course, resourcing component 124 can query business system 104 for other information as well. Querying for resources is indicated by block 278 in FIG. 2, and querying for other information is indicated by block 280. Receiving and displaying the resource data for user 106 is indicated by block 282.

FIG. 3G shows one embodiment of a user interface display 284 for displaying returned resources. Display 284 is similar to the display shown in FIG. 3F, and similar items are similarly numbered. However, FIG. 3G shows that resourcing component 124 illustratively displays resources in a list display 286. The resources are displayed along with a user input mechanism 288 that allows user 106 to add additional resources, if desired.

In the embodiment shown in FIG. 3G, the resources being displayed are human resources, or workers. They are displayed by name in column 300. It should also be noted that additional information, such as the user's experience, position, etc. can be displayed as well. Alternatively, the user can highlight a given worker (such as by clicking or double clicking on the user) and that information can be displayed in an additional display. Display 286 also illustratively includes selection mechanism 288, such as a check box corresponding to each worker displayed in column 302. User 106 can select a worker by actuating the corresponding check box adjacent the worker. The user can then staff a given task in project 121 using the selected worker. Receiving user selection of a resource (or worker) for a selected task is indicated by block 304 in the flow diagram of FIG. 2.

In response, staffing component 130 illustratively staffs the selected task with the selected worker, and displays this to user 106. FIG. 3H shows one embodiment of a user interface display that illustrates this. User interface display 306 shown in FIG. 3H is similar to the user interface display shown in FIG. 3F, and similar items are similarly numbered. However, it can be seen in FIG. 3H that individual workers have now been assigned to individual tasks in resource column 252. Assigning the selected resources to the selected tasks is indicated by block 308 in the flow diagram of FIG. 2.

Once the individual workers have been assigned to the tasks by staffing component 130, publication component 126 again publishes the staffed project 121 to business system 104. This is indicated by block 310 in the flow diagram of FIG. 2. In response, staffing component 158 illustratively reserves the resources (e.g., the workers) that have been assigned to project 121 within business system 104. Reserving those workers for the stored project plan 152 (that corresponds to project 121 in project planning system 102) within business system 104 is indicated by block 312 in FIG. 2. Staffing component 158 also generates the necessary authorizations for those workers to begin recording time and expenses against the project plan 152. This is indicated by block 314.

Accounting component 150 then automatically generates or updates the cost and revenue estimates, per task, based upon the individuals that have been assigned to those tasks within business system 104. By way of example, different individual workers may have different billing rates. Therefore, once the individuals are actually assigned to the tasks, accounting component 150 can update the estimated cost and revenue data (154 and 156, respectively) corresponding to plan 152 based on the actual billing rates for the assigned workers. This is indicated by block 316 in FIG. 2.

Business system 104 can take other actions as well, and this is indicated by block 318. For instance, budgeting component 164 may automatically generate a baseline budget based upon the new estimates for project plan 152. Of course, other actions are contemplated herein as well.

User 106 can also provide additional inputs to project planning system 102, for project 121. For instance, it may be that user 106 wishes to generate a budget in planning system 102 using the cost and revenue estimates that were updated by accounting component 150 in business system 104. User 106 thus provides appropriate user inputs to budgeting component 132 to generate and execute on the budget. Receiving inputs generating a budget 134 based upon the cost and revenue estimates 154 and 156, respectively, is indicated by block 320.

Based on the inputs by user 106, budgeting component 132 then outputs a budget 134 for display to the user. FIG. 3I shows one user interface display 322 that indicates this. It can be seen that user interface display 322 includes an identification section 324 that generally identifies the project ID, project name, activity number and activity name, as well as a number of hours that have been booked versus a number of hours that are remaining (as budgeted) for this activity. User input mechanisms allow the user to input all of these items. Display 322 includes a resource section 326 that either allows the user to have resources automatically or manually assigned, and it includes sections that identify the work being done, the worker that has been assigned to the work, and the date and the hours of work that have been recorded by that worker. It also illustratively includes an estimation section 328 that estimates the costs and revenues for a given worker, along with a number of specific items, such as the quantity (or hours) that are estimated for this task, for this worker, as well as the unit sales price and cost price and the total sales and cost prices, among other things. It will be appreciated that the budgeting information (e.g., the estimated revenue and costs) that are generated per task and shown in FIG. 3I are exemplary only. Other information can be shown as well.

At any time during the project, it may be that user 106 enters update information that updates the project 121 within project management system 102. When that occurs, synchronization component 128 illustratively acts to synchronize that information back to business system 104. Likewise, when changes are made to the stored project plan 152 within business system 104, those changes are also synchronized to project 121 in project planning system 102, again using synchronization component 128. It will be noted that, while synchronization component 128 is shown in project management system 102, it can be located in business system 104 instead. Also, synchronization components can be located in both systems 102 and 104. The synchronization component that is shown in project management system 102 is shown for the sake of example only. Synchronizing changes between the two systems is indicated by block 330 in FIG. 2.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

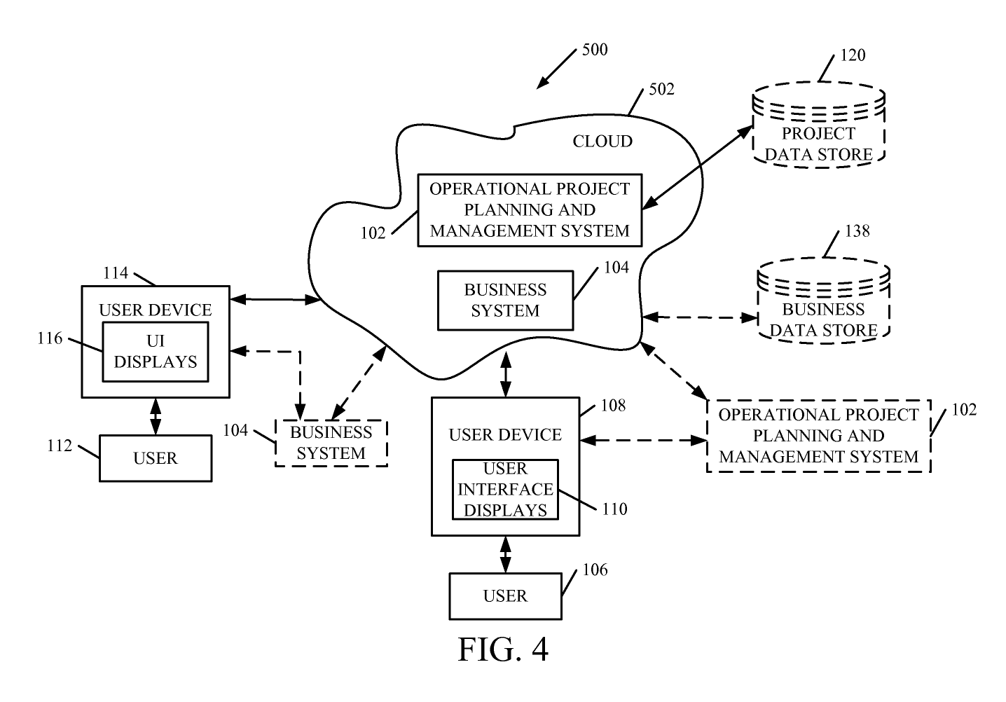

FIG. 4 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the embodiment shown in FIG. 4, some items are similar to those shown in FIG. 1 and they are similarly numbered. FIG. 4 specifically shows that project management system 102 and business system 104 can be located in cloud 502 (which can be public, private, or a combination where portions are public while others are private). Therefore, users 106 and 112 use user devices 108 and 114 to access those systems through cloud 502.

FIG. 4 also depicts another embodiment of a cloud architecture. FIG. 4 shows that it is also contemplated that some elements of architecture 100 can be disposed in cloud 502 while others are not. By way of example, data stores 122 and 138 can be disposed outside of cloud 502, and accessed through cloud 502. In another embodiment, business system 104 and/or project planning system 102 can be outside of cloud 502. Regardless of where they are located, they can be accessed directly by devices 108 and 114, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

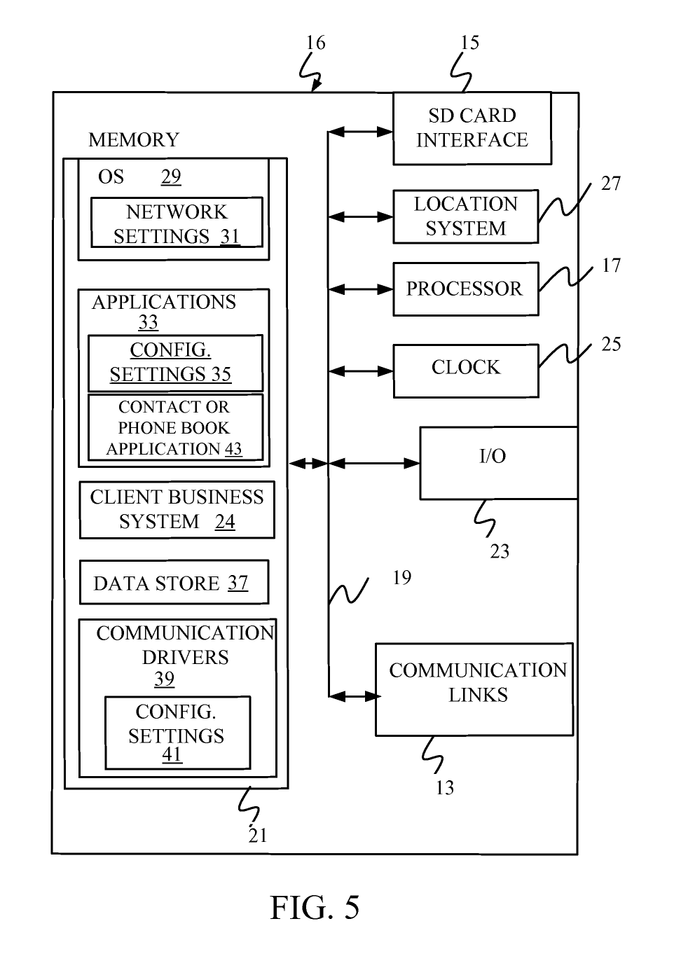

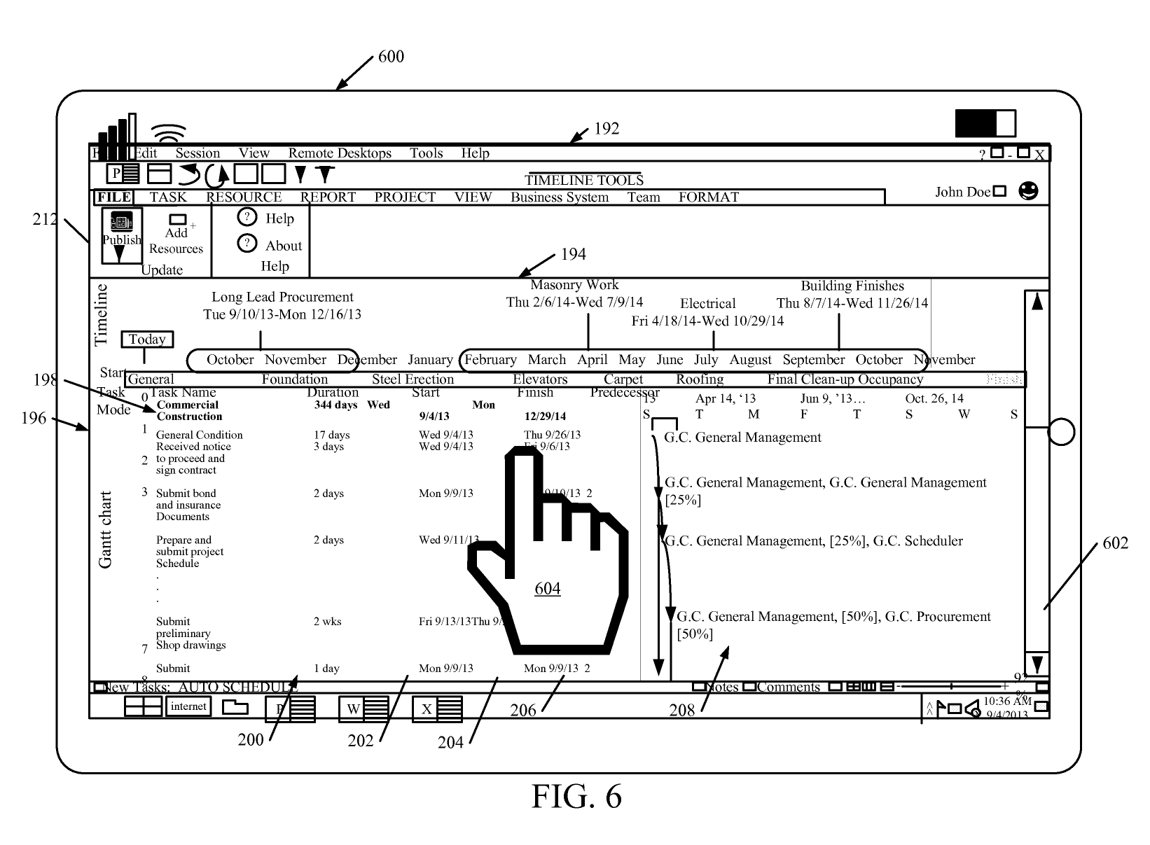

FIG. 5 is a simplified block diagram of one illustrative embodiment of a handheld or mobile computing device that can be used as a user's or client's hand held device 16, in which the present system (or parts of it) can be deployed. FIGS. 6-10 are examples of handheld or mobile devices.

FIG. 5 provides a general block diagram of the components of a client device 16 that can run components of architecture 100 or that interacts with architecture 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems (like on-premise business application 176) are received on a removable Secure Digital (SD) card that is connected to a SD card interface 15. SD card interface 15 and communication links 13 communicate with a processor 17 (which can also embody processors 118 or 136 or processors in the user devices from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 6 shows one embodiment in which device 16 is a tablet computer 600. In FIG. 6, computer 600 is shown with user interface display from FIG. 3A displayed on the display screen 602. Screen 602 can be a touch screen (so touch gestures from a user's finger 604 can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

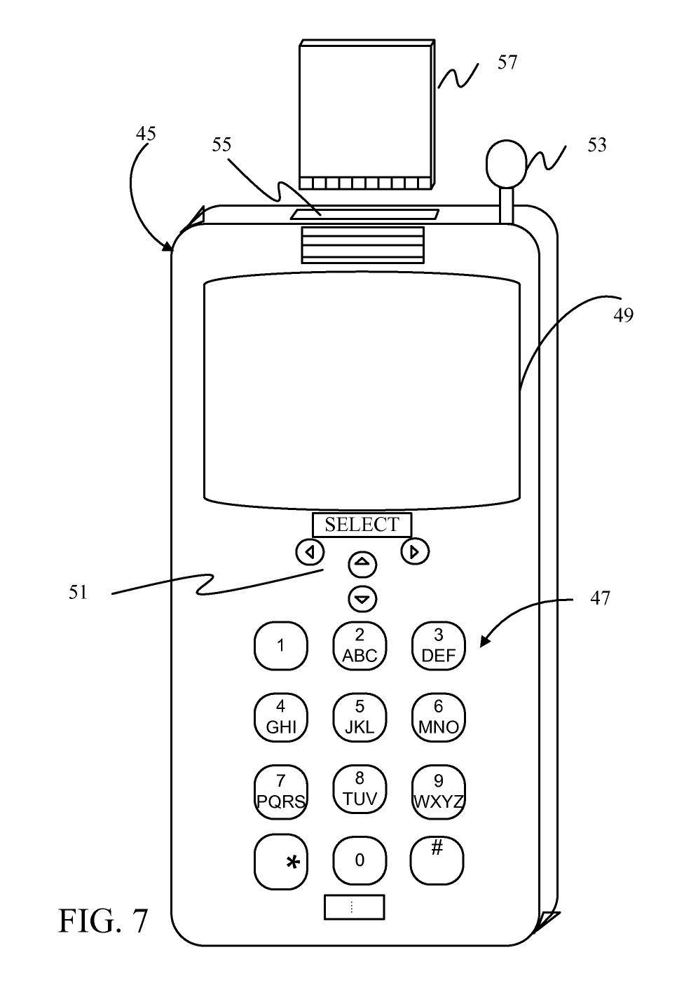

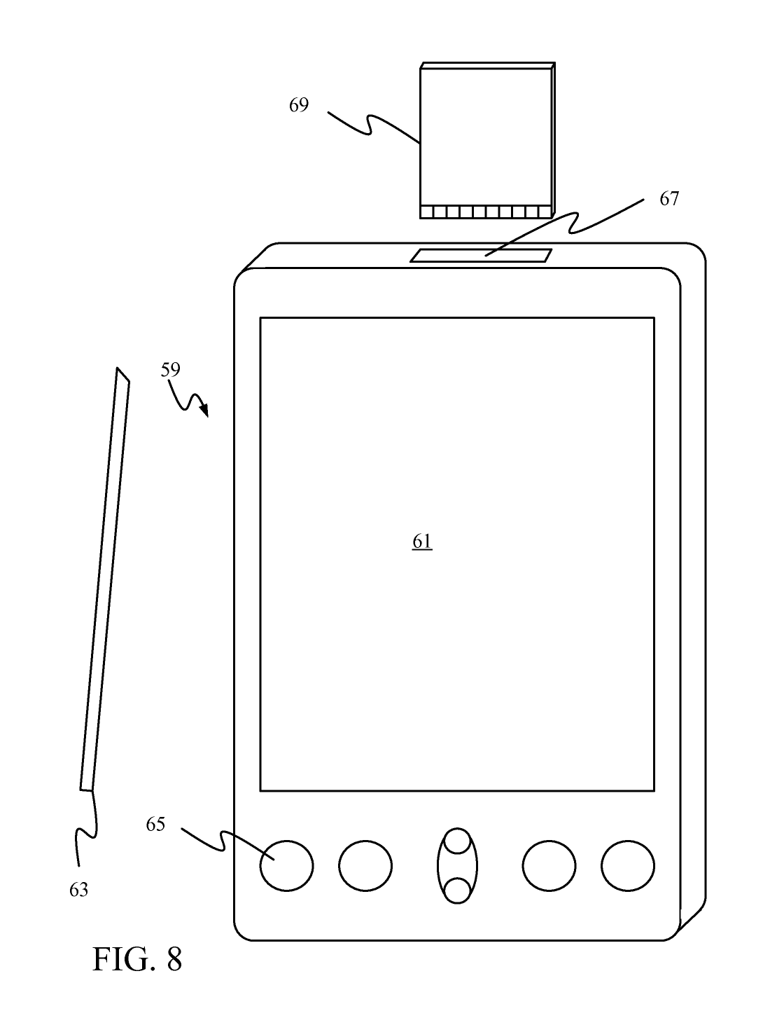

FIGS. 7 and 8 provide additional examples of devices 16 that can be used, although others can be used as well. In FIG. 7, a feature phone, smart phone or mobile phone 45 is provided as the device 16. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1Xrtt, and Short Message Service (SMS) signals. In some embodiments, phone 45 also includes a Secure Digital (SD) card slot 55 that accepts a SD card 57.

The mobile device of FIG. 8 is a personal digital assistant (PDA) 59 or a multimedia player or a tablet computing device, etc. (hereinafter referred to as PDA 59). PDA 59 includes an inductive screen 61 that senses the position of a stylus 63 (or other pointers, such as a user's finger) when the stylus is positioned over the screen. This allows the user to select, highlight, and move items on the screen as well as draw and write. PDA 59 also includes a number of user input keys or buttons (such as button 65) which allow the user to scroll through menu options or other display options which are displayed on display 61, and allow the user to change applications or select user input functions, without contacting display 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 59 also includes a SD card slot 67 that accepts a SD card 69.

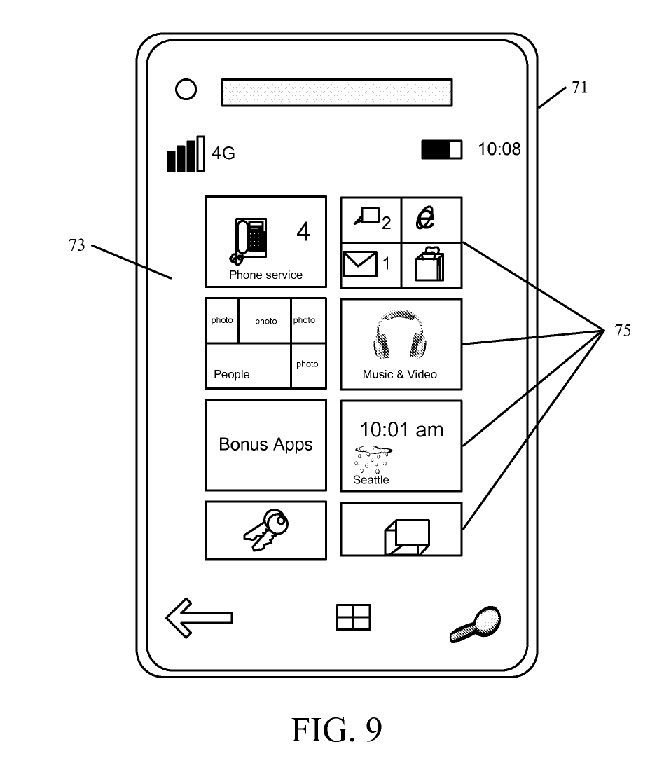

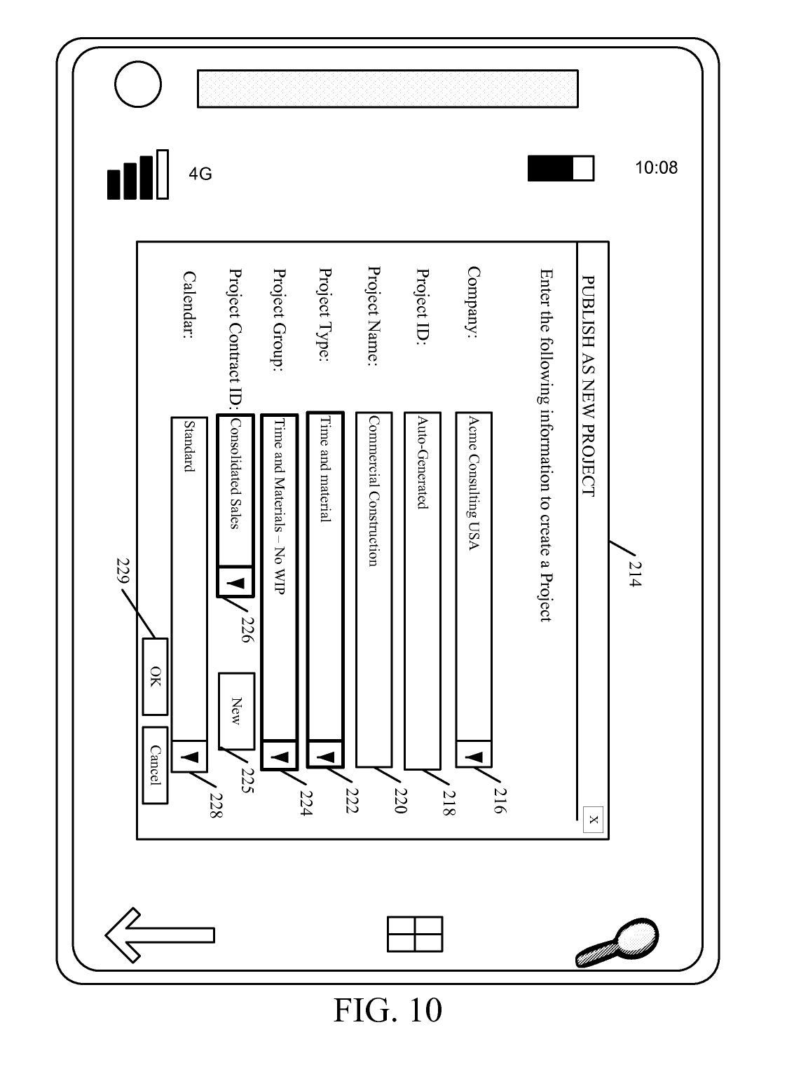

FIG. 9 is similar to FIG. 7 except that the phone is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone. FIG. 10 shows phone 71 with the display from FIG. 3B displayed on it.

Note that other forms of the devices 16 are possible.

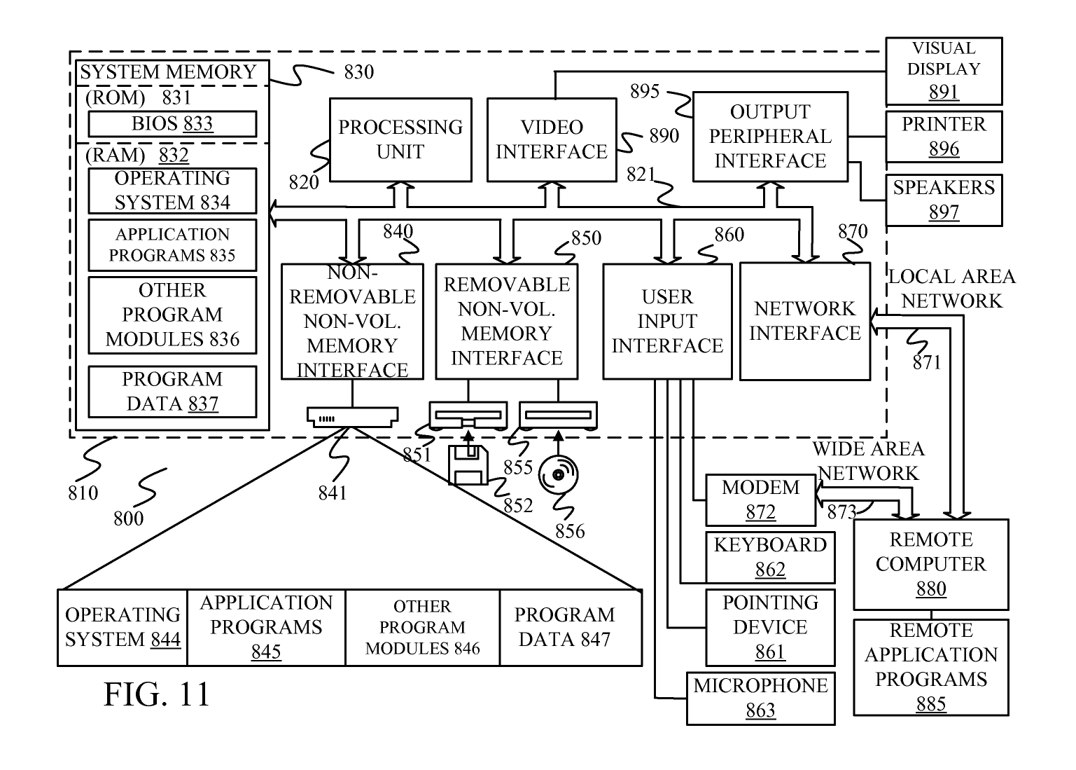

FIG. 11 is one embodiment of a computing environment in which architecture 100, or parts of it, (for example) can be deployed. With reference to FIG. 11, an exemplary system for implementing some embodiments includes a general-purpose computing device in the form of a computer 810. Components of computer 810 may include, but are not limited to, a processing unit 820 (which can comprise processor 118 or 136 or processors in user devices 108 or 114), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 11.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 11 illustrates operating system 834, application programs 835, other program modules 836, and program data 837.

The computer 810 may also include other removable/non-removable volatile/nonvolatile computer storage media. By way of example only, FIG. 11 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 11, provide storage of computer readable instructions, data structures, program modules and other data for the computer 810. In FIG. 11, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 10 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 11 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method, comprising:
displaying, with a project planning system, a project creation user interface display with project creation user input mechanisms that receive user inputs creating a project;
sending project information indicative of the project to a business system; automatically displaying, with the project planning system, reference data, received from the business system based on the project information, with user interaction input mechanisms; and
receiving user interaction inputs, through the user interaction input mechanisms, interacting with the reference data to modify portions of the project using the reference data.

2. The computer-implemented method of claim 1 wherein sending project information indicative of the project to the business system comprises:
publishing the project to the business system.

3. The computer-implemented method of claim 2 wherein publishing the project comprises:
automatically querying the business system for financial and operational reference data.

4. The computer-implemented method of claim 3 wherein displaying the project creation user interface display comprises:
displaying project creation user input mechanisms that include task input mechanisms that receive task user inputs defining tasks in the project.

5. The computer-implemented method of claim 4 wherein automatically querying comprises:
automatically querying the business system for category data indicative of categories in the business system that correspond to the tasks in the project in the project planning system.

6. The computer-implemented method of claim 5 wherein receiving user interaction inputs comprise:
receiving user assignment inputs assigning the tasks to categories in the business system based on the category data received from the business system.

7. The computer-implemented method of claim 4 and further comprising:
receiving a user resourcing input;
automatically querying the business system for resources maintained by the business system; and
displaying, at the project planning system, returned resources, returned from the business system, for user selection.

8. The computer-implemented method of claim 7 wherein receiving user interaction inputs comprises:
receiving user selection of a given resource for staffing a given task; and
assigning the given resource to the given task in the project in the project planning system.

9. The computer-implemented method of claim 8 and further comprising:
republishing the project to the business system with the given resource assigned to the given task; and
receiving estimated cost data and estimated revenue data from the business system for the given task, with the given resource assigned to it.

10. The computer-implemented method of claim 9 and further comprising:
displaying a budgeting user interface display at the project planning system with budget user input mechanisms that receive budget user inputs; and
generating a budget based on the budget user inputs and the estimated cost data and the estimated revenue data.

11. The computer-implemented method of claim 1 and further comprising:
displaying a contract creation user interface display with contract creation user input mechanisms at the project management system; and
receiving contract user inputs to create a contract based on returned financial and operational reference data and based on the contract user inputs.

12. A project planning system, comprising:
a project creation component that generates a project creation user interface display with project creation user input mechanisms that receive project user inputs defining a work definition for a project;
a publication component that publishes the work definition for the project to a business system and receives reference data corresponding to the project, from the business system, the project creation component automatically displaying the reference data, receiving user interaction inputs, and applying at least a portion of the reference data to the project based on the user interaction inputs; and
a computer processor that is a functional part of the system and is activated by the project creation component and the publication component to facilitate receiving project user inputs, publishing, automatically displaying and applying.

13. The project planning system of claim 12 wherein the project creation components receives user inputs to define tasks in the work definition and wherein the publication component automatically queries the business system for operational reference data including categories in the business system that correspond to the tasks defined in the work definition.

14. The project planning system of claim 13 wherein the project creation component receives the user interaction inputs selecting a given task and assigning the given task to a given category.

15. The project planning system of claim 12 and further comprising:
a resourcing component that displays a resourcing user input mechanism and, in response to actuation of the resourcing user input mechanism, automatically queries the business system for resources to assign to the work definition and that displays returned resources that are returned by the business system in response to the query.

16. The project planning system 15 and further comprising:
a staffing component that generates a staffing user interface display that has staffing user input mechanisms that receive user inputs selecting a given resource for assignment to the work definition, and that assigns the given resource to the work definition.

17. The project planning system of claim 13 wherein the publication component automatically queries the business system for financial information corresponding to the project and displays the financial information for use in the project.

18. A computer readable storage medium that stores computer readable instructions which, when executed by the computer, cause the computer to perform steps, comprising:
displaying, with a project planning system, a project creation user interface display with project creation user input mechanisms that include task input mechanisms that receive task user inputs defining tasks in a project;
sending project information indicative of the project to a business system;
automatically querying the business system for financial and operational reference data including category information indicative of business system categories that correspond to the tasks in the project;
automatically displaying, with the project planning system, the financial and operational reference data with user interaction input mechanisms; and
receiving user interaction inputs, through the user interaction input mechanisms, interacting with the reference data to modify portions of the project using the reference data.

19. The computer readable storage medium of claim 18 and further comprising:
receiving a user resourcing input;
automatically querying the business system for resources maintained by the business system;
displaying, at the project planning system, returned resources, returned from the business system, for user selection;
receiving user selection of a given resource for staffing a given task; and
assigning the given resource to the given task in the project planning system.

20. The computer readable storage medium of claim 19 and further comprising:
resending the project to the business system with the given resource assigned to the given task; and
receiving estimated cost data and estimated revenue data from the business system for the given task, with the given resource assigned to it.
